(19) United States
(12) Patent Application Publication
(10) Pub. No.: US 2026/0298606 A1
(43) Pub. Date: Oct. 1, 2026

(54) COUNTING ASSEMBLY FOR A MEASURING WHEEL

(71) Applicant: Apex Brands, Inc., Apex, NC (US)

(72) Inventors: Rodney Andrew THOMAS, Raleigh, NC (US); Michael DUNIGAN, Apex, NC (US); Matthew STAEHLE, Raleigh, NC (US)

(21) Appl. No.: 19/479,431

(22) PCT Filed: Apr. 26, 2024
(86) PCT No.: PCT/US2024/026385

§ 371 Date: Oct. 28, 2025

Related U.S. Application Data
(60) Provisional application No. 63/462,778, filed on Apr. 28, 2023.

(51) Int. Cl. G01B 3/12; G01C 22/00; G06M 1/08

(52) U.S. Cl. CPC G01B 3/12; G01C 22/00; G06M 1/083

(57) ABSTRACT

A measuring wheel may include a wheel assembly which may include at least one wheel, a handle assembly which may include a handle and a shaft, a housing to which the handle and the wheel assembly may be operably coupled, and an analog counting assembly which may convert rotation of the at least one wheel into a distance traveled by the measuring wheel. The analog counting assembly may include a counter disposed at the handle of the measuring wheel, and a flexible cable to both enable the handle shaft to fold and mechanically operably couple the counter to the wheel assembly for measuring the distance traveled when the handle shaft may not be folded.

### TECHNICAL FIELD

Example embodiments generally relate to measuring equipment and, in particular, relate to a measuring wheel.

### BACKGROUND

Typical measuring tools such as wheeled markers and measuring wheels may be used in surveying, sports, and other activities. Some measuring wheels may have a shaft that extends upwardly from a wheel assembly to allow the operator to control the measuring wheel. Certain capabilities for starting, stopping and resetting measuring functions may be executable at the handle the operator grasps, or at a housing provided proximate to the wheel assembly. Other functions may also be provided at the housing or at the handle. However, when the measuring wheel is under positive control of the operator, the operator may need to easily see the total distance counted in order to operate the measuring wheel effectively. Thus, reading the distance counter should not be an arduous task, and should be doable quickly, and anywhere.

Thus, it may be desirable to provide a new design for a measuring wheel counting assembly. Additionally, it may be desirable for the new design to be more robust, reliable, accurate, cost-efficient, and/or easy to manufacture compared to pre-existing measuring wheels.

### BRIEF SUMMARY OF SOME EXAMPLES

Some example embodiments may provide for a measuring wheel. The measuring wheel may include a wheel assembly which may include at least one wheel, a handle assembly which may include a handle and a shaft, a housing to which the handle assembly and the wheel assembly may be operably coupled, and an analog counting assembly which may convert rotation of the at least one wheel into a distance traveled by the measuring wheel. The analog counting assembly may include a counter disposed at the handle of the measuring wheel, and a flexible cable which may enable the handle shaft to fold and which may mechanically operably couple the counter to the wheel assembly for measuring the distance traveled when the handle shaft may not be folded.

Some example embodiments may provide for an analog counting assembly for a measuring wheel. The analog counting assembly may include a counter which may be disposed at a handle of the measuring wheel, a flexible cable which may mechanically operably couple the counter to a wheel assembly of the measuring wheel, a first gear mesh which may operably couple the flexible cable to the counter at a first end of the flexible cable, and a second gear mesh which may operably couple the flexible cable to the wheel assembly at a second end of the flexible cable. The analog counting assembly may convert rotation of at least one wheel of the wheel assembly into a distance traveled by the measuring wheel.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a measuring wheel according to an example embodiment;

FIG. 2 illustrates a perspective view of a handle of the measuring wheel according to an example embodiment;

FIG. 3 illustrates a section view of the handle of the measuring wheel according to an example embodiment;

FIG. 4 illustrates a close up perspective view of the first gear mesh according to an example embodiment;

FIG. 5 illustrates a section view of the handle of the measuring wheel according to an example embodiment;

FIG. 6 illustrates a perspective view of the wheel assembly according to an example embodiment;

FIG. 7 illustrates a close up perspective view of the second gear mesh according to an example embodiment;

FIG. 8 illustrates a perspective view of the second gear mesh according to an example embodiment;

FIG. 9 illustrates a perspective view of the second gear mesh according to an example embodiment;

FIG. 10 illustrates a section view of the third bevel gear according to an example embodiment;

FIG. 11 illustrates a perspective view of the hinge assembly according to an example embodiment;

FIG. 12 illustrates a perspective view of the hinge assembly according to an example embodiment;

FIG. 13 illustrates a perspective view of the first collar according to an example embodiment;

FIG. 14 illustrates a side view of the hinge assembly according to an example embodiment;

FIG. 15 illustrates a section view of the handle of the measuring wheel according to an example embodiment;

FIG. 16 illustrates a close up perspective view of the first gear mesh according to an example embodiment;

FIG. 17 illustrates a perspective view of the hinge assembly according to an example embodiment;

FIG. 18 illustrates an exploded view of the hinge assembly according to an example embodiment; and

FIG. 19 illustrates a perspective view of the first collar according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

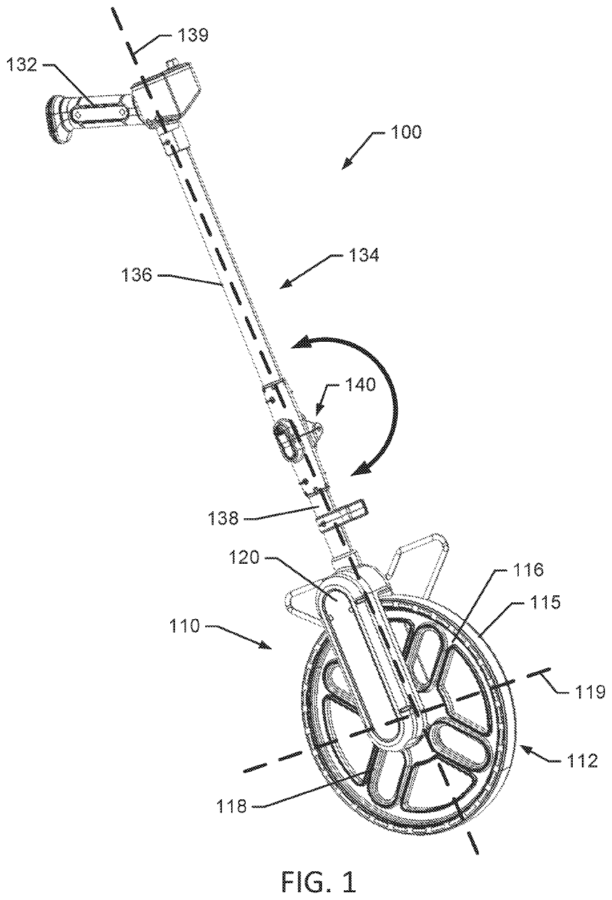

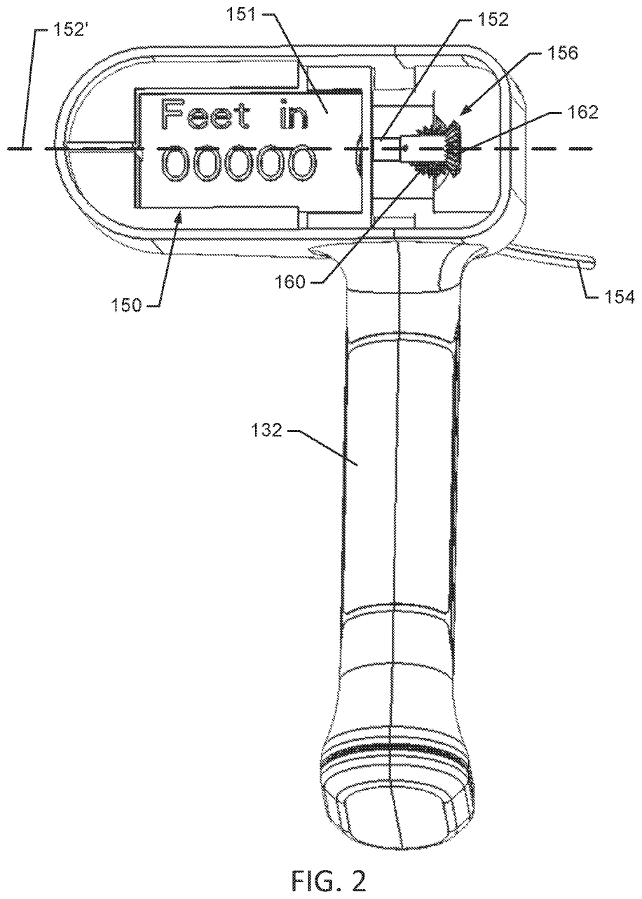

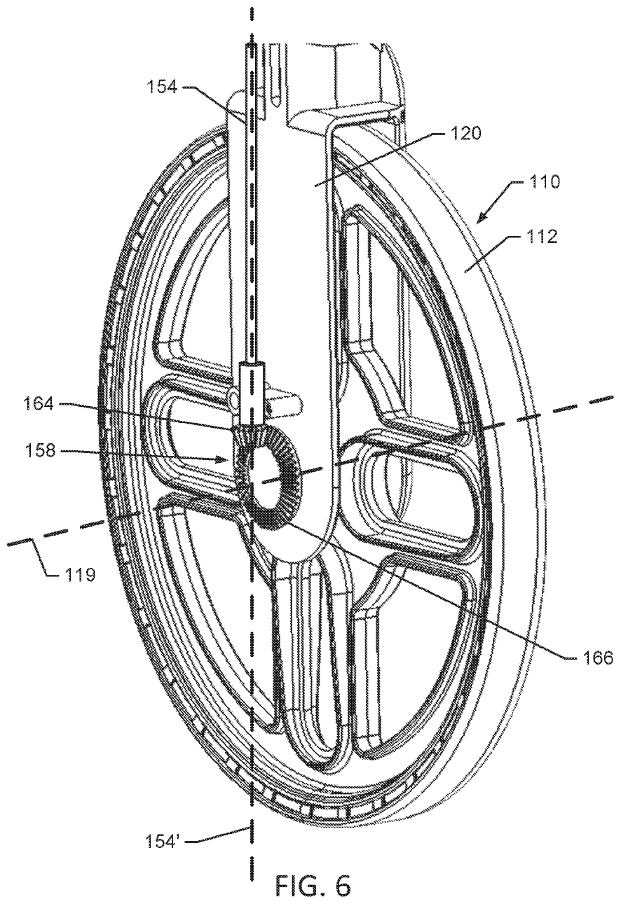

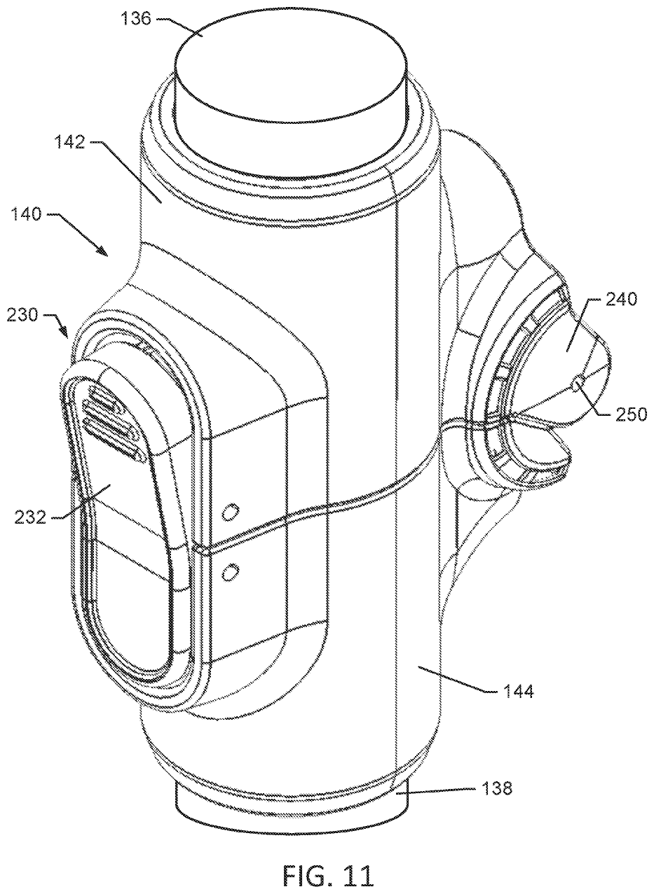

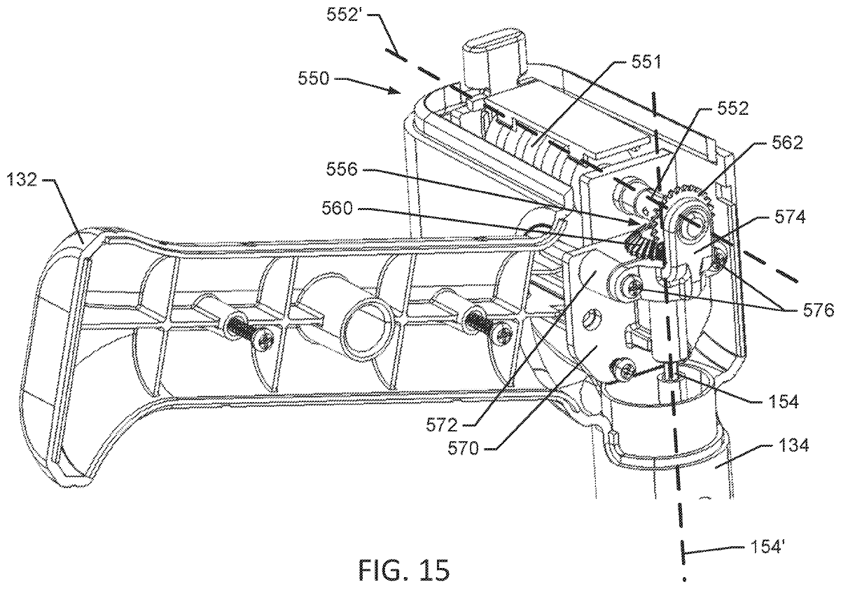

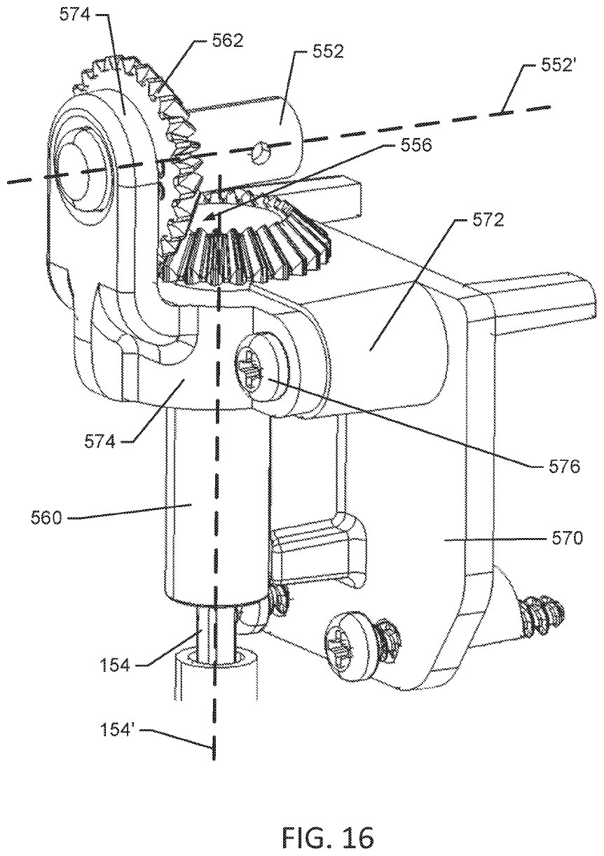

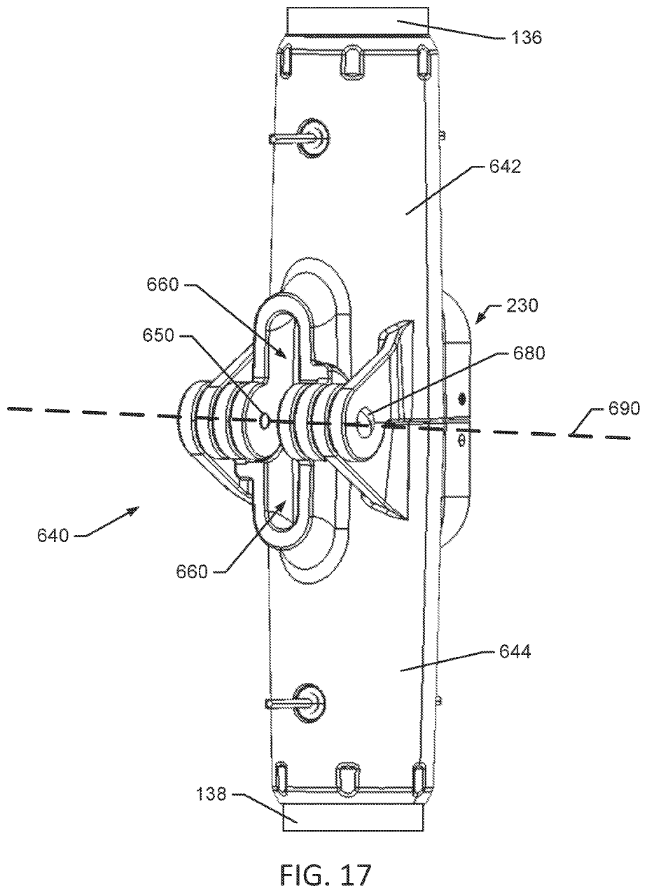

FIG. 1 illustrates a perspective view of the measuring wheel 100 in accordance with an example embodiment. FIGS. 2-5 illustrate other views of a handle assembly 130 to facilitate further discussion of the structures associated with the measuring wheel 100 in accordance with example embodiments. FIGS. 6-10 illustrate views of a second gear mesh 158 to facilitate further discussion of the structures associated with the measuring wheel 100 in accordance with example embodiments. FIGS. 11-14 illustrate views of a hinge assembly 140 to facilitate further discussion of the structures associated with the measuring wheel 100 in accordance with example embodiments. FIGS. 15 and 16 depict an alternate embodiment of the handle assembly 130 and first gear mesh 156 having a support bracket 574. FIGS. 17-19 depict an alternate embodiment of the hinge assembly 640 having additional hinge lobes 645.

Referring to FIG. 1, the measuring wheel 100 may include a wheel assembly 110, a housing 120, and a handle assembly 130. In some cases, the wheel assembly 110 may include at least one wheel 112. The at least one wheel 112, in some embodiments, may include a tire portion 115 which may surround a rim portion 116. However, the rim portion 116 and the tire portion 115 could be combined in some examples. If a rim portion 116 is included, the rim portion 116 may be operably coupled to a wheel hub disposed at a center of the at least one wheel 112 via one or more spoke assemblies 118. The spoke assemblies 118 may include individual spoke members that are spaced apart from each other. The spoke assemblies 118 may form a plurality of different shapes and patterns. In the embodiment of FIG. 1, the spoke assemblies 118 may be disposed in an oval shape, with similarly shaped structures extending between the wheel hub and the rim portion 116. In an example embodiment, the at least one wheel 112 may rotate or turn about an axis of rotation 119. The axis of rotation 119 may be defined to extend along or through a wheel axle about which the at least one wheel 112 turns.

The wheel axle about which the at least one wheel 112 rotates may extend through a housing 120 that may house one or more functional components of the measuring wheel 100. The functional components may include a function button. The function button may be used to control the operation of an accessory that may be housed in or otherwise operably coupled to the housing 120. The accessory may be, for example, a marking device, a pneumatic tool, a camera, or the like. In an example embodiment in which the accessory is a marking device, the marking device may include chalk, paint and/or the like. In an example embodiment in which the accessory is a pneumatic tool, the accessory may be, for example, a stake driver, nail gun, or the like. The operator may depress the function button to start the performance of a function (e.g. applying a marking, etc.) and release the function button to stop the performance of the function. However, in other instances, the function button may operate to start/stop various other functions of the measuring wheel 100. The function button and other functional components may alternatively or additionally be disposed at the handle assembly 130, such as in the handle 132, described below.

The measuring wheel 100 may also include a handle assembly 130 that may include a handle 132 and a handle shaft 134. The handle 132 may be disposed at a distal end of the handle shaft 134 from the housing 120, proximate to an operator of the measuring wheel 100 so that the operator may operate the measuring wheel 100 appropriately. In some cases, the handle assembly 130 may further include a hinge assembly 140, which may allow the handle shaft 134 to alternatingly pivot between an extended state and a compact state. In this regard, the handle shaft 134 may, in examples that employ the hinge assembly 140, include two or more portions that may pivot relative to each other, via the hinge assembly 140, to change the overall length of the measuring wheel 100. For example, in the extended state, a first portion 136 and a second portion 138 of the handle shaft 134 may be disposed end-to-end and coaxial about a shaft axis 139, while the operator is operating the measuring wheel 100. On the other hand, the operator may desire to store the measuring wheel 100 while it is not in use. In order for the measuring wheel 100 to take up less space, the handle shaft 134 may be put into the compact state in which the first portion 136 and the second portion 138 may be disposed side-by-side and substantially parallel to each other. Further, while the handle 132 may be disposed at a distal end of the handle shaft 134 from the housing 120 when the handle shaft 134 may be in the extended state, when the handle shaft 134 may be in the compact state, the handle 132 may be disposed proximate to the housing 120 and the wheel assembly 110. Accordingly, the hinge assembly 140 may be operable between the extended state and the compact state to alter the length of the handle shaft 134.

In some embodiments, the measuring wheel 100 may include an analog counting assembly 150. The analog counting assembly 150 may be configured to convert rotation of the wheel assembly 110 into a distance traveled by the measuring wheel 100. The analog counting assembly 150 may include a counter 151, a counter shaft 152, a flexible cable 154, a first gear mesh 156 and a second gear mesh 158. The flexible cable 154 may mechanically convey rotation of the wheel assembly 110 to the counter 151, as will be discussed below in reference to FIGS. 2-10.

FIGS. 2-7 depict various views of the analog counting assembly 150, according to an example embodiment. As described above, the analog counting assembly 150 may convert rotation of the wheel assembly 110 into a distance traveled by the measuring wheel 100. In some cases, such as the embodiment depicted in FIGS. 2-7, this may be accomplished mechanically via rotating various components operably coupled to one another. As shown in FIG. 2, the counter 151 may be disposed at the handle 132. As such, the counter 151 may be closer to the operator so that the operator may more easily read the numerical value corresponding to the distance traveled by the measuring wheel 100 on a display of the counter 151 and, in some embodiments, may more easily reset the counter to zero via operation of a reset button located at the handle 132. In some cases, the display may be digital with the distance traveled being shown by digital numbers. In such cases, the counter 151 may include a power source (i.e. a battery) to supply power the display as needed. In some other cases, the display may be analog and the distance traveled may be shown with physical rotary numbers. In any case, the counter 151 may be operably coupled to the counter shaft 152, which may provide input rotation to the counter 151. The counter 151 may then translate the input rotation from the counter shaft 152 into the numerical value corresponding to the distance traveled by the measuring wheel 100 via either the digital display or the analog display described above.

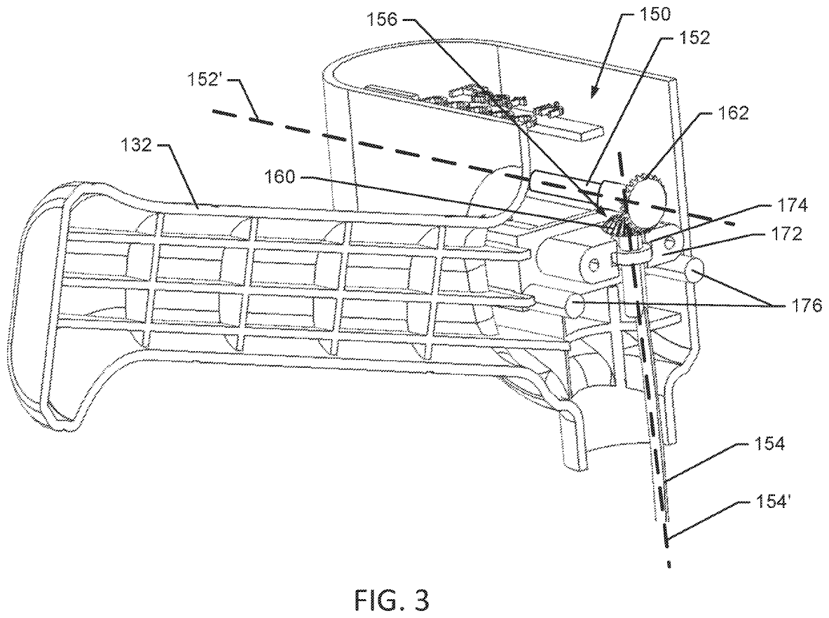

As shown in FIG. 3, the counter shaft 152 may be operably coupled to the flexible cable 154 via the first gear mesh 156. In this regard, the first gear mesh 156 may include a first bevel gear 160 operably coupled to a first end of the flexible cable 154 and a second bevel gear 162 operably coupled to the counter shaft 152. The first and second bevel gears (160, 162) may be oriented at approximately 90° to one another within the first gear mesh 156 such that the flexible cable 154 may extend substantially perpendicular to the counter shaft 152, and down the handle shaft 134 towards the wheel assembly 110. In this regard, the counter shaft 152 may rotate about an axis of rotation 152′ responsive to the flexible cable 154 rotating about its own axis of rotation 154′ that may be substantially perpendicular to the counter shaft axis of rotation 152′. The first and second bevel gears (160, 162) may accordingly be rotatably operably coupled via teeth disposed at each of the first and second bevel gears (160, 162). The flexible cable 154 may thus convey a rotational force from the wheel assembly 110 to the counter shaft 152, via the first gear mesh 156, and the counter 151 may accordingly convert the rotation of the counter shaft 152 into the distance traveled by the measuring wheel 100.

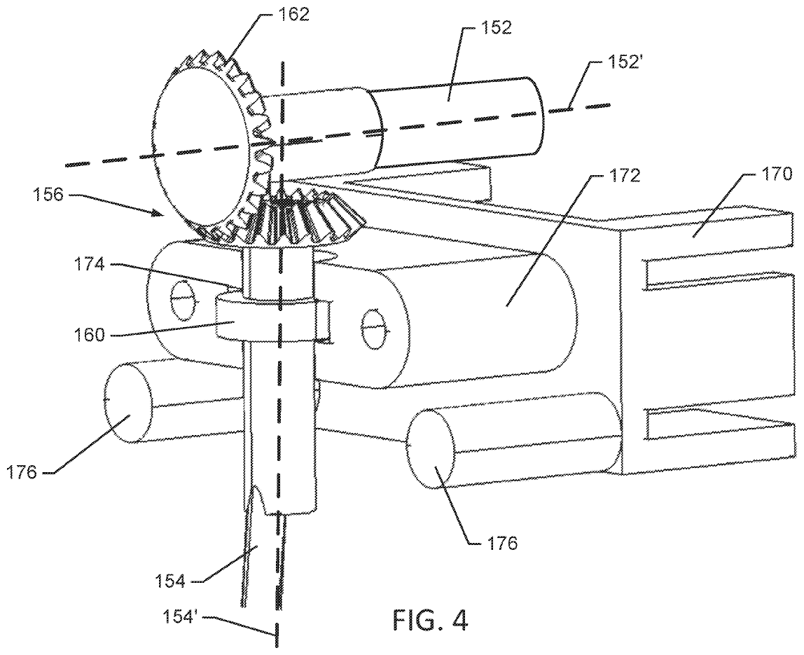

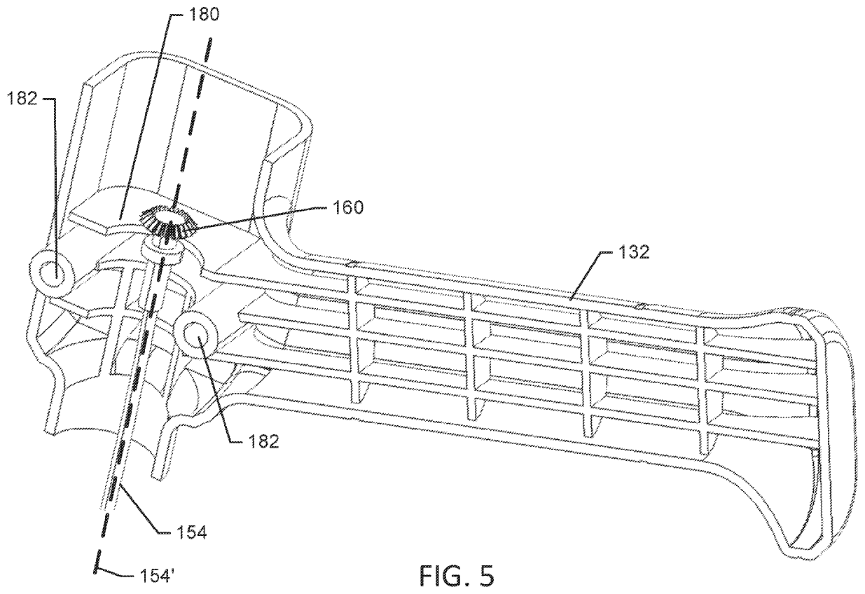

FIGS. 4 and 5 depict two different perspective views of the first gear mesh 156, according to an example embodiment. In FIG. 4, the first gear mesh 156 may be shown being supported by a handle alignment member 170. The handle alignment member 170 may support the first gear mesh 156 proximate to the counter 151 so that the first gear mesh 156 operably couples the flexible cable 154 to the counter shaft 152. In other words, the handle alignment member 170 may support the first bevel gear 160 so that the first bevel gear 160 may be in precisely the correct position to operably couple with the second bevel gear 162 to transmit the rotational motion of the flexible cable 154 to the counter shaft 152 and ultimately to the counter 151. In this regard, the handle alignment member 170 may include a projection tab 172 with a groove 174 disposed in an end thereof. The groove 174 may receive a portion of the first bevel gear 160 therein so that the first bevel gear 160 may be free to rotate with the flexible cable 154 but also remain in position to operably couple with the second bevel gear 162 disposed at the counter shaft 152.

In the embodiment of FIG. 5, the handle 132 may include a support member 180 that may operably couple the first bevel gear 160 to the handle alignment member 170 in order to properly locate the first bevel gear 160 in the groove 174 of the handle alignment member 170. In some cases, the support member 180 may be an extension of the handle 132 that may be positioned to bias the first bevel gear 160 into the groove 174 to prevent the first bevel gear 160 from exiting the groove 174 and exiting the operable coupling with the second bevel gear 162. In this regard, the support member 180 may also act as a bearing surface for the flexible cable 154 in that the first bevel gear 160 may rotate relative to the support member 180 and to the groove 174 to transmit the rotational motion from the flexible cable 154 to the counter shaft.

Also seen in FIGS. 4 and 5, the handle alignment member 170 may further include a pair of locating pins 176. The pair of locating pins 176 may operably couple with a pair of locating orifices 182 in the handle 132 responsive to the handle 132 being assembled. Responsive to the pair of locating pins 176 in the handle alignment member 170 operably coupling with respective ones of the pair of locating orifices 182, the support member 180 may operably couple with the first bevel gear 160 to retain the first bevel gear 160 within the groove 174. In other words, the pair of locating pins 176 may operably couple to the pair of locating orifices 182 to help align the support member 180 with the first bevel gear 160 to ensure a proper fitment and operation of the first gear mesh 156.

As seen in FIG. 4, in the first gear mesh 156, the second bevel gear 162 may extend substantially perpendicular to the first bevel gear 160 to form a T-shape engagement of the first and second bevel gears (160, 162). In other words, the second bevel gear 162 may be disposed substantially horizontal (i.e. parallel) to a ground plane along which the measuring wheel 100 may be operated, and the first bevel gear 160 may be disposed substantially vertical (i.e. normal) to the ground plane. The second bevel gear 162 may thus engage with the first bevel gear 160 at an opposite side of the first bevel gear 160 from the projection tab 172. This particular orientation may be beneficial for rotation direction purposes within the counting assembly 150. For example, as the measuring wheel 100 moves forward in direction during use, the flexible cable 154 may rotate clockwise. Thus, for the counter 151 to increment proportionally to the distance covered by the measuring wheel 100, the second bevel gear 162 may also rotate clockwise. In some other embodiments, however, the counter 151 may be configured to increment in a counterclockwise direction, and in such cases, the second bevel gear 162 may engage with the first bevel gear 160 in a position disposed on a directly opposite side of the first bevel gear 160, so that the first bevel gear 160 may turn the second bevel gear 162 in the counterclockwise direction. The second bevel gear 162, which may be secured to the counter shaft 152 via a pin, may also help to bias the first bevel gear 160 into the groove 174 of the projection tab 172 by imparting a biasing force on the first bevel gear 160 directed parallel to the counter shaft 152 and towards the counter 151. In this regard, the second bevel gear 162 may be fixed in the axial direction via its operable coupling with the counter shaft 152. The counter 151, which may also be disposed in the handle and fixed in place via further support structures (e.g. ribs), may thus impart the biasing force onto the first bevel gear 160 via the counter shaft 152 and the second bevel gear 162. This orientation of the first gear mesh 156 may result in more secure support for the first gear mesh 156 via the projection tab 172.

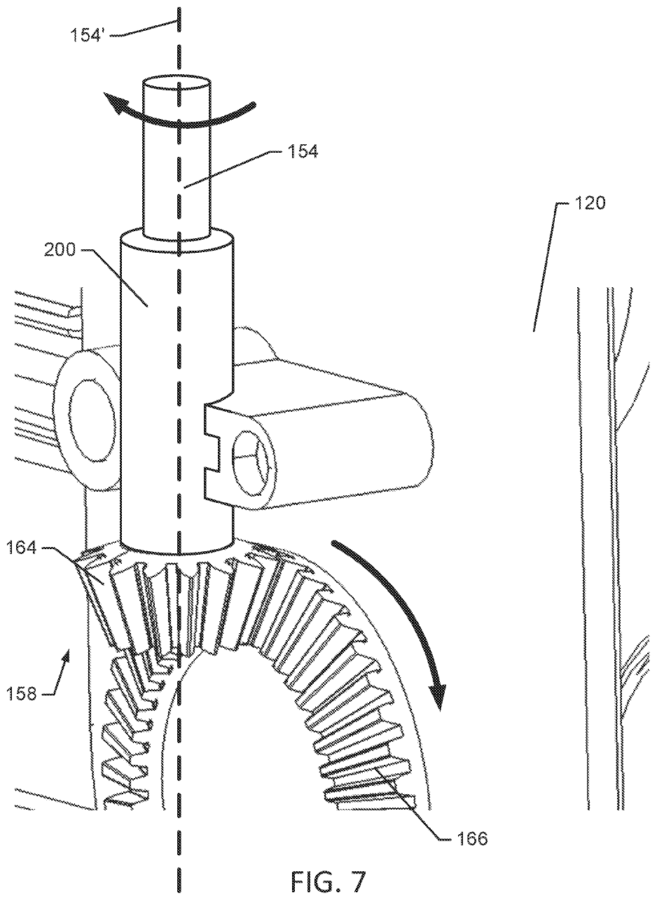

FIGS. 6 and 7 depict various views of the housing 120, the second gear mesh 158 and the wheel assembly 110, all according to an example embodiment. As shown in FIG. 6, the second gear mesh 158 may operably couple the flexible cable 154 to the wheel assembly 110 via a third bevel gear 164 and a fourth bevel gear 166. In some cases, the third bevel gear 164 may be operably coupled to a second end of the flexible cable 154 and the fourth bevel gear 166 may be operably coupled to the wheel assembly 110. In this regard, the wheel assembly 110 may be rotatably operably coupled to the fourth bevel gear 166 via an axle that may be configured to rotate about a wheel axis of rotation 119 that may extend through a center of the wheel assembly 110 and also through a center of the fourth bevel gear 166. As such, the wheel assembly 110 and the fourth bevel gear 166 may rotate together and about the same axis of rotation 119.

In some cases, the at least one wheel 112 of the wheel assembly 110 may have a diameter within a range of 11.75 inches to 12.25 inches in order to balance considerations of cost, manufacturability, size, function, and ergonomics. In order to optimize considerations of measurement accuracy, production time and costs, the counter, the gear ratios and the exact diameter of the wheel 112 may be selected to yield gear ratios for the first, second, third and fourth bevel gears (160, 162, 164 and 166) that require the least amount of teeth to be machined on each bevel gear (160, 162, 164 and 166) while maintaining accuracy of measurement between the distance the wheel travels and the counter's display. In this regard, the wheel 112 may have a diameter of approximately 11.9 inches. In an example embodiment, the 11.9 inch wheel is important because it may yield an accurate measurement with the first bevel gear 160 having 21 teeth, the second bevel gear 162 having 23 teeth, the third bevel gear 164 having 15 teeth, and the fourth bevel gear 166 having 45 teeth, which may be the most efficient possible outcome for the ratio of gears in terms of accuracy of measurement and the time and cost of manufacturing each gear for a measuring wheel 100 being marketed as a 12 inch diameter wheel. In other words, in some embodiments, the measuring wheel 100 has a gear ratio of the drive gear versus the driven gear of approximately 21:23 for the first gear mesh 156 and approximately 3:1 for the second gear mesh 158.

The third bevel gear 164 may be disposed proximate to the fourth bevel gear 166 and may be secured in place via a gear alignment member 190. Similar to the handle alignment member 170 for the first gear mesh 156, the gear alignment member 190 may support the third bevel gear 164 in a precise position to maintain the operable coupling of the third bevel gear 164 to the fourth bevel gear 166 via teeth disposed on each gear (164, 166). Also similar to the handle alignment member 170, the gear alignment member 190 may operably couple to the third bevel gear 164 in such a manner that the third bevel gear 164 may rotate relative to the gear alignment member 190.

Thus, in some embodiments, responsive to the at least one wheel of the wheel assembly 110 rotating about its axis of rotation 119, the second gear mesh 158 may rotate the flexible cable 154 about its axis of rotation 154′. The wheel axis of rotation 119 may be substantially perpendicular to the flexible cable axis of rotation 154′. Responsive to the flexible cable 154 rotating about its axis of rotation 154′, the first gear mesh 156 may rotate the counter shaft 152 about its axis of rotation 152′. The counter shaft axis of rotation 152′ may be substantially perpendicular to the flexible cable axis of rotation 154′ and substantially parallel to the wheel axis of rotation 119. In other words, the wheel axis of rotation 119 and the counter shaft axis of rotation 152′ may be substantially parallel to a surface along which the measuring wheel 100 travels, while the flexible cable axis of rotation 154′ may be substantially perpendicular to the surface on which the measuring wheel 100 travels.

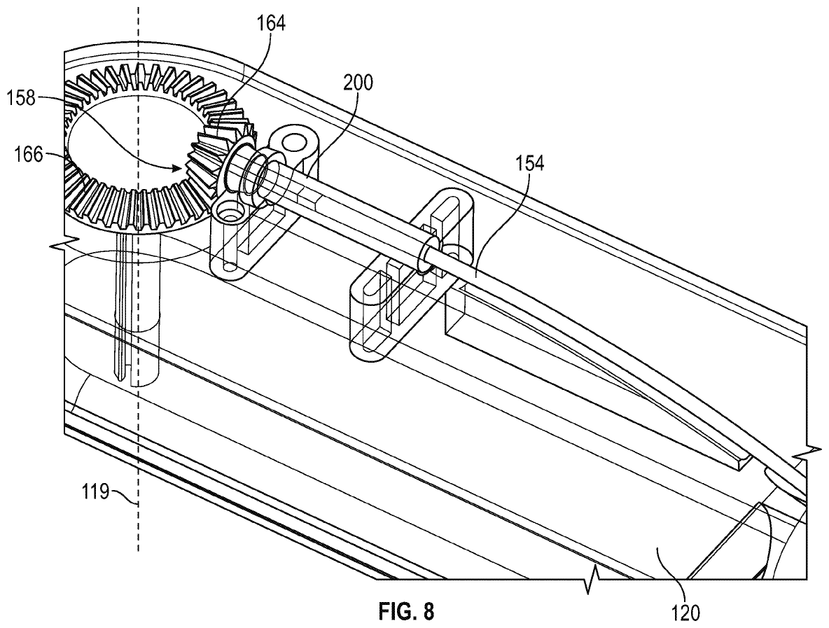

FIGS. 8-10 depict perspective views of the third bevel gear 164 according to an example embodiment. The third bevel gear 164 may include a cable tension mitigation assembly disposed therein. In this regard, the third bevel gear 164 may include cylindrical body 200, that may be elongated in the direction of the flexible cable axis of rotation 154′. In some embodiments, the body 200 may include a hollow core 210 extending into the body 200 also in the direction of the flexible cable axis of rotation 154′. In this regard, the flexible cable 154 may operably couple to the third bevel gear 164 via a sliding fit within the hollow core 210 at the second end of the flexible cable 154. The sliding fit may allow the flexible cable 154 to move axially along the flexible cable axis of rotation 154′ within the hollow core 210, yet maintain the ability of the flexible cable 154 to convey rotation from the third bevel gear 164 to the first bevel gear 160. Accordingly, the operable coupling of the flexible cable 154 to the third bevel gear 164 may mitigate tension in the flexible cable 154.

It may be desirable to maintain the flexible cable 154 within a range between a state of there being excessive tension in the cable 154 and a state of there being excessive slack in the cable 154, in order to maintain accurate operation of the counter 151 of the measuring wheel 100. For instance, if the flexible cable 154 were to have excessive slack in between the respective operable couplings at the first and second ends of the flexible cable 154 (and thus between the first and second gear meshes 156, 158), then the flexible cable 154 may not rotate precisely with the wheel assembly 110. In this regard, the flexible cable 154 may be more likely to become twisted without conveying the rotational motion to the counter 151 if the flexible cable 154 were to have excessive amounts of slack. Thus, it may be desirable to minimize the slack in the flexible cable 154 to maintain the accuracy of the counter 151 in the measuring wheel 100. On the other hand, some example embodiments of the measuring wheel 100 may include a handle shaft 134 with a hinge assembly 140 that may configured to allow the handle shaft 134 to fold essentially in half at the hinge assembly 140. In such cases, the flexible cable 154 may be pulled taught by the act of folding the handle shaft 134 due to the flexible cable 154 extending around a 180°bend in the handle shaft 134. Thus, the tension mitigation assembly may allow for the second end of the flexible cable 154 to slide a predetermined distance relative to the third bevel gear 164 and still remain operable coupled to the third bevel gear 164 in order to relieve some of the tension from the flexible cable 154 responsive to the folding of the handle shaft 134 about the hinge assembly 140. In other words, the tension mitigation assembly may provide just enough extra length of flexible cable 154 to permit the flexible cable 154 to bend 180°when the handle shaft 134 is folded, but also avoid having bends in the flexible cable 154 when the handle shaft 134 is not folded and is instead fully extended. The predetermined distance that the flexible cable 154 may slide may be defined by a length of the hollow core 210 of the third bevel gear 164, and by a location of the hinge assembly 140. In an example embodiment, the predetermined distance may be within a range of 15 mm to 45 mm. In some cases, the predetermined distance may be approximately 28 mm. The length of the hollow core 210 may thus be at least as long as the predetermined distance, but in many embodiments may be longer. The structure of the third bevel gear 164 will be discussed in greater detail below in reference to FIGS. 8-10 and the structure of the hinge assembly 140 will be discussed in greater detail below in reference to FIGS. 11-14.

Importantly, as described herein, the tension mitigation assembly may be disposed at the second gear mesh 158, and more specifically, at the third bevel gear 164. However, in some example embodiments, the tension mitigation assembly may also be disposed at the first gear mesh 156, or more specifically, at the first bevel gear 160. In still some other embodiments, there may be more than one tension mitigation assembly, where each gear mesh (156, 158) may include their own respective tension mitigation assemblies. In the present embodiment described herein, having the tension mitigation assembly disposed at the second gear mesh 158 may be advantageous because the flexible cable 154 in this case may be working with the force of gravity rather than against it. In this regard, with the tension mitigation assembly disposed at the second gear mesh 158, there may be less of a chance that the flexible cable 154 becomes unintentionally separated from the hollow core 210 since gravity may help pull the flexible cable 154 down into the hollow core 210 of the third bevel gear 164. If, for example, the tension mitigation assembly were disposed at the first gear mesh 156, the flexible cable 154 may be more likely to be separated from the hollow core 210 as a result of gravity pulling the flexible cable 154 out of the hollow core 210 if it were to be disposed in the first bevel gear 160. Such separation may lead to inaccuracies within the counting assembly 150. As such, it may be advantageous to work with the force of gravity rather than against it.

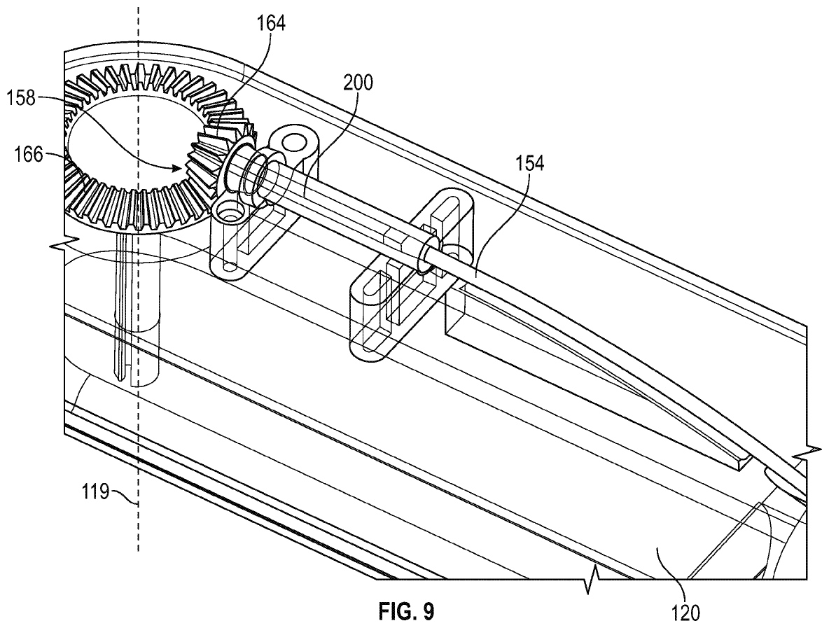

Therefore, FIGS. 8 and 9 may depict perspective views of the second gear mesh 158 with the flexible cable 154 depicted operably coupled to the hollow core 210 of the third bevel gear 164. In FIG. 8, the flexible cable 154 may be shown operably coupled to the third bevel gear 164 with the handle assembly 130 may be in the extended state. In this regard, the measuring wheel 100 may be ready to be operated with the hinge assembly 140 operably coupling the first and second portions of the shaft (136, 138) end-to-end and the flexible cable 154 may extend between the first and second gear meshes (156, 158) in a substantially straight line along the flexible cable axis of rotation 154′. As such, the flexible cable 154 may be disposed in the hollow core 210 at a deeper position (i.e. more of the flexible cable 154 is disposed within the hollow core 210). In FIG. 9, the flexible cable 154 may be shown operably coupled to the third bevel gear 164 with the handle assembly 130 may be in the compact state. Responsive to the handle assembly 130 entering the compact state, in which the first and second shaft portions (136, 138) may pivot at the hinge assembly 140 to be disposed substantially parallel to each other, the flexible cable 154 may be disposed in the hollow core 210 at a shallower position (i.e. less of the flexible cable 154 is disposed within the hollow core 210).

The shallower position of the flexible cable 154 may be a result of the flexible cable 154 being pulled on by a tension force due to the flexible cable 154 bending 180° around the hinge assembly 140 responsive to the handle shaft 134 being in the compact state. In this regard, the flexible cable 154 may be able to “float” within the body 200 of the third bevel gear 164. In other words, the flexible cable 154 may not operably couple to a particular fixed location within the hollow core 210, but rather may slide within the hollow core 210 to provide some tension relief and slack reduction to the flexible cable 154, depending on which position the handle shaft 134 of the measuring wheel 100 may be in. For example, if there is excessive amounts of slack in the flexible cable 154, the second end of the flexible cable 154 may slide deeper into the hollow core 210 of the third bevel gear 164 due to a force from the slack acting on the second end of the flexible cable 154. On the other hand, if the flexible cable 154 needs more slack (i.e. the flexible cable 154 is taught), then the flexible cable 154 may slide partially out of the hollow core 210 due to being pulled out by the rest of the flexible cable 154. In other words, the tension or lack thereof in the flexible cable 154 may mitigated by the flexible cable's 154 slidable operable coupling with the third bevel gear 164.

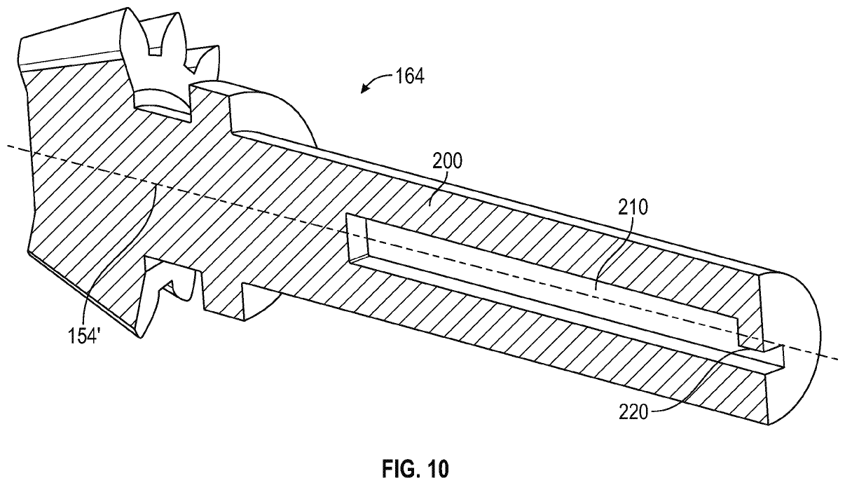

FIG. 10 depicts a section view of the third bevel gear 164 in accordance with an example embodiment. As seen in FIG. 10, the hollow core 210 may extend through the elongated cylindrical body 200 of the third bevel gear 164. In some cases, the hollow core 210 may include a protrusion 220 which may prevent the flexible cable 154 from completely exiting the hollow core 210. In this regard, the protrusion 220 may be disposed proximate to an open end of the hollow core 210 and may extend from the body 200 into the hollow core 210 to encroach on the hollow core 210. Accordingly, the protrusion 220 may define an exit channel of the hollow core which may have a reduced cross sectional area through which the flexible cable 154 may slide. The protrusion 220 may stop the flexible cable 154 at the second end to prevent it from sliding out of the hollow core 210. In some cases, the flexible cable 154 may include a first diameter at the first end and a second diameter at the second end. In some cases, the second diameter may be larger than both the first diameter and the exit channel in order to catch on the protrusion 220 within the hollow core.

In an example embodiment, the hollow core 210 and the second end of the flexible cable 154 may each include a rectangular cross sectional shape. This may aid in transferring rotational motion from the third bevel gear 164 to the flexible cable 154 while minimizing any slipping between the flexible cable 154 and the hollow core 210. Minimizing slipping in the analog counting assembly 150 may be desirable to obtain the most accurate distance measurements as possible at the counter 151. In some cases, the entire flexible cable 154 may have a rectangular cross sectional shape. In some other cases, the rectangular cross sectional shape may be reserved for specific locations along the flexible cable 154, such as the first and second ends where the flexible cable 154 may operably couple to the first and second gear meshes (156, 158), respectively. In other embodiments, the hollow core 210 and the flexible cable 154 cross sections may have other polygonal shapes, such as hexagonal cross-sections. In some embodiments, the flexible cable 154 cable may be comprised of a flexible metallic or polymeric rod within a protective sleeve, where the rod may be exposed at respective ends to operably couple with the first and third bevel gears (160, 164) and configured to rotate within the protective sleeve.

FIGS. 11-14 depict various views of the hinge assembly 140 according to an example embodiment. The hinge assembly 140 may pivotably operably couple the first portion 136 of the handle shaft 134 to the second portion 138 of the handle shaft 134. The first portion 136 may be operably coupled to the handle 132 at a first end of the first portion 136 and to the hinge assembly 140 at a second end of the first portion 136. On the other hand, the second portion 138 may be operably coupled to the hinge assembly 140 at a first end of the second portion 138 and to the housing at a second end of the second portion 138. In this regard, the hinge assembly 140 may include a first collar 142 operably coupled to the second end of the first portion 136 and a second collar 144 operably coupled to the first end of the second portion 138. The first and second collars (142, 144) may be pivotably operably coupled to each other to achieve the hinging action of the handle shaft 134. In some cases, the first and second collars (142, 144) may operably couple to an exterior surface of the first and second portions (136, 138) of the handle shaft 134, respectively. As such, an interior of the first and second portions (136, 138) may be unobstructed. This may be desirable to improve the operation of the flexible cable 154 that may reside therein. In other words, if the flexible cable 154 were to get caught on something, it may be inhibited from transferring rotational motion to the counter 151. Thus, operably coupling the first and second collars (142, 144) to the exterior surface of the first and second portions (136, 138) may improve the operation of the flexible cable 154.

As shown in FIG. 11, the hinge assembly 140 may further include a latch assembly 230. The latch assembly 230 may physically operably couple the first collar 142 to the second collar 144 when the handle shaft 134 is in the extended state. In the compact state, the latch assembly 230 may be operably coupled to only one of the first or second collars (142, 144). In this regard, the latch assembly 230 may be operable between a locked state and an unlocked state, and may include a latch 232 and a spring 234 or other form of biasing means. The latch 232 may be pivotably operably coupled to either of the first or second collars (142, 144) at a middle of the latch 232, while the spring 234 may be disposed at an end of the latch 232 between the latch 232 and the collar (142 or 144). Thus, in the locked state, the spring 234 may bias the opposite end of the latch 232 from the end it may be disposed at into contact with the respective opposing collar (142, 144) from the collar (142, 144) to which the latch 232 is operably coupled. In other words, the latch assembly 230 may be thought of as a simple machine lever where the latch 232 is the lever itself and the latch 232 may operably couple to the first or second collar (142 or 144) at the fulcrum of the lever. One end of the latch 232 may have the spring 234 disposed between the latch 232 and the collar (142 or 144) and the spring 234 may bias that end of the latch 232 away from the collar (142 or 144). In doing so, the opposing end of the latch 232 may be biased into contact with the opposing collar (142 or 144). Thus, the end of the latch 232 to which the spring 234 is operably coupled may be depressed to release the latch 232 from the locked state and put it into the unlocked state. In the unlocked state, the hinge assembly 140 may be free to rotate the handle shaft 134 into the compact state from the extended state.

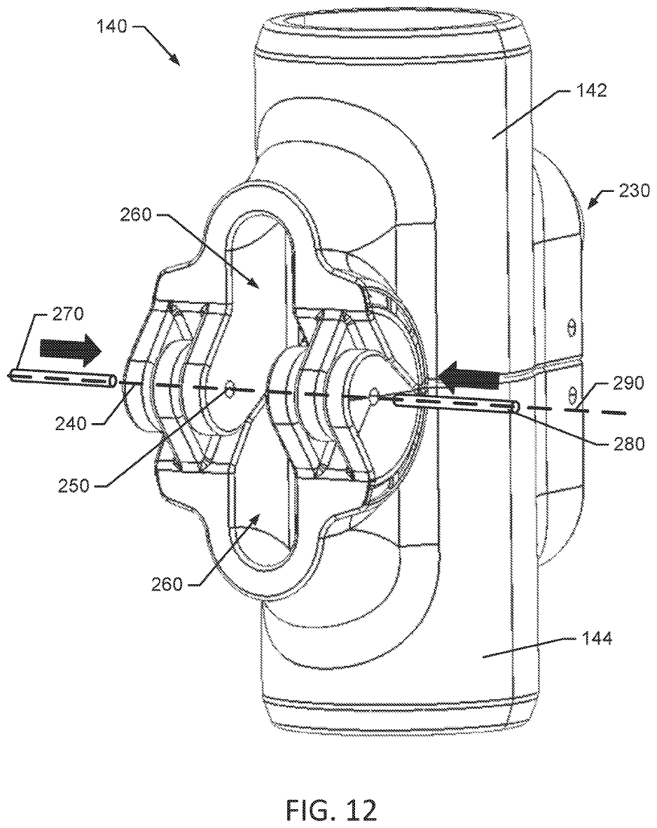

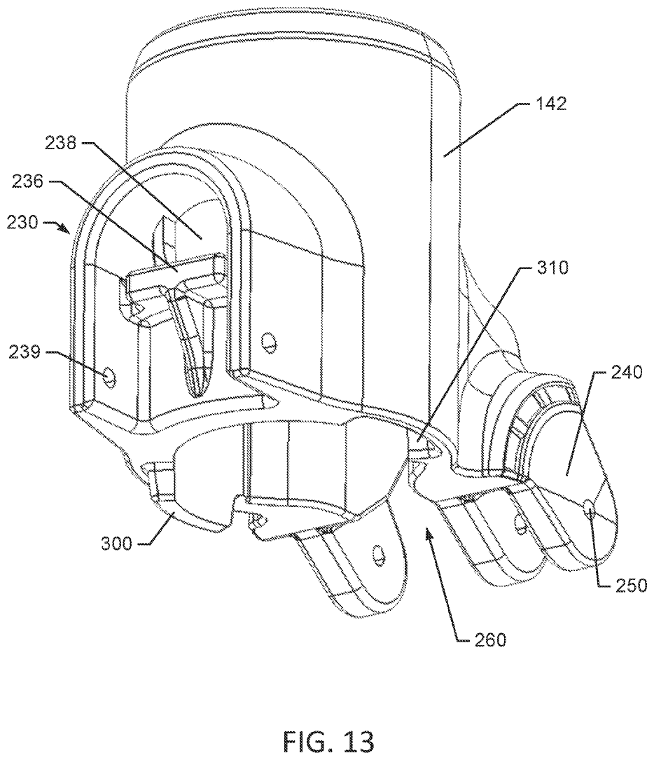

FIG. 12 depicts a rear perspective view of the hinge assembly 140 according to an example embodiment, and FIG. 13 depicts a perspective view of the first collar 142 according to an example embodiment. In order to hingedly operably couple to one another, the first and second collars (142, 144) may each include at least one hinge lobe 240, and each hinge lobe 240 may include a bore 250 that may extend through a thickness of the hinge lobe 240. In fact, each of the first and second collars (142, 144) may include a total of three hinge lobes 240, which may be the lowest possible count to ensure that the first and second collars (142, 144) cannot be separated laterally. The hinge lobes 240 may be disposed into two distinct sets that may be separated by a cable relief channel 260 extending between each set. Accordingly, in some embodiments, each collar (142, 144) may include a first set of hinge lobes 240 which may include a first hinge lobe 240 and a second set of hinge lobes 240 which may include both the second and third hinge lobes 240. It should be appreciated, however, that in other cases, more or fewer hinge lobes 240 may be provided in total and/or in each set. In any case, the first set of hinge lobes 240 of the first collar 142 may pivotably operably couple with the second set of hinge lobes 240 of the second collar 144 via a first pin 270 extending through the bore 250 in each hinge lobe 240. Similarly, the first set of hinge lobes 240 of the second collar 144 may pivotably operably couple with the second set of hinge lobes 240 of the first collar 142 via a second pin 280 extending through the bore 250 in each hinge lobe 240. In an example embodiment, the first and second pins (270, 280) may be coaxially disposed along a pivot axis 290 and on opposing sides of the cable relief channel 260. Therefore, the hinge assembly 140 may include two, or perhaps more in some cases, pins (270, 280) to pivotably operably couple the first collar 142 to the second collar 144 via the hinge lobes 240.

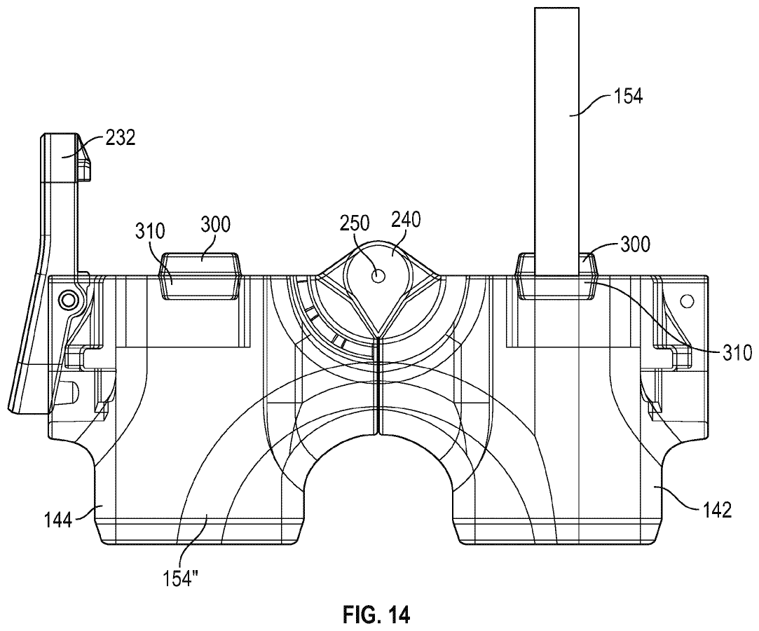

Therefore, as discussed above, the hinge assembly 140 may be operable between an extended state in which the first and second shaft portions (136, 138) may be coaxial and disposed end-to-end (as seen in FIG. 11), and a compact state where first and second shaft portions (136, 138) may be substantially parallel and disposed side-by-side (as seen in FIG. 14). In an example embodiment, the first and second shaft portions (136, 138) may rotate up to 180° when exiting the extended state and going into the compact state.

FIG. 13 depicts a perspective view of the first collar 142 according to an example embodiment. In an example embodiment, the first and second collars (142, 144) may be a reflection of each other. In other words, they may be the same part with the same features, just flipped to operably couple with each other. In some cases, each of the first and second collars (142, 144) may include a male locating member 300 and a female locating member 310. In this regard, in the extended state, the male locating member 300 of the first collar 142 may operably couple to the female locating member 310 of the second collar 144 and the male locating member 300 of the second collar 144 may operably couple to the female locating member 310 of the first collar 142. Accordingly, the male and female locating members (300, 310) may ensure that the first and second collars (142, 144) align properly when pivoting into the extended state from the compact state. In doing so, the male and female locating members (300, 310) on each collar (142, 144) may help keep the interior region of the handle shaft 134 and the hinge assembly 140 unobstructed for proper rotation of the flexible cable 154 disposed therein. In other words, in the extended state, the first shaft portion 136, the first collar 142, the second collar 144 and the second shaft portion 138 may form a hollow cylindrical tube through which the flexible cable 154 may extend from the first gear mesh 156 to the second gear mesh 158. In contrast to that, in the compact state, the first collar 142 and the second collar 144 may form a 180° corner between the first and second shaft portions (136, 138). Thus, in the compact state, the flexible cable 154 may bend 180° to extend through the first and second collars (142, 144).

FIG. 13 also depicts the latch assembly 230 with the latch 232 removed. The latch assembly 230 may further include a lip 236 to which the latch 232 may operably couple to via a snap fit when the latch assembly is in the locked state. FIG. 13 may also show the spring retention orifice 238 in which the spring 234 may be disposed when the latch assembly 230 is assembled on the hinge assembly 140, and the latch pin orifice 239 where the latch 232 is pivotably operably coupled to the hinge assembly 140 via a pin. In this regard, the latch 232 may pivotably operably couple to the first collar 142 via the pin extending through the latch pin orifice 239, and the latch 232 may also operably couple to the second collar 144 via the snap fit with the lip 236. In some embodiments, the latch assembly 230 may be reversed, and the latch 232 may pivotably operably couple to the second collar 144 via the pin extending through the latch pin orifice 239, and to the first collar 142 via the snap fit with the lip 236. Whichever collar (142 or 144) to which the latch 232 is pivotably operably coupled via the pin may be the collar (142 or 144) in which the spring 234 may be disposed in the spring retention orifice 238.

FIG. 14 depicts the hinge assembly 140 pivoted into the compact state, according to an example embodiment. As shown in FIG. 14, in the compact state, the cable relief channel 260 on the first collar 142 may align with the cable relief channel 260 on the second collar 144 to form a bend to support the flexible cable 154 while in the compact state. In other words, the cable relief channels 260 from each collar (142, 144) may align with one another responsive to the hinge assembly 140 entering the compact state. The cable relief channels 260 may combine to form a bend on which the flexible cable 154 may rest responsive to the handle shaft 134 entering the compact state. In some cases, the bend may be a continuous surface formed by the contact between the first and second collars (142, 144) while in the compact state that may relieve/prevent increased tension on the flexible cable 154 responsive to the handle assembly 130 entering the compact state by supporting the flexible cable 154 on a same side of the pivot axis 290 as the wheel assembly 110. In other words, rather than the flexible cable 154 be stretched out over the pivot axis 290 of the hinge assembly 140 responsive to the hinge assembly entering the compact state, the flexible cable 154 may pass through the pivot axis 290 and be supported by the bend formed by the contact between the cable relief channels 260. In FIG. 14, this transition may be indicated by the depiction of two flexible cables 154 and 154″. Importantly, the depiction of the two flexible cables 154 and 154″ may represent the same singular flexible cable 154 both in the extended state and in the compact state. In this regard, the flexible cable 154 extending straight up and down may represent the flexible cable 154 in the extended state while the curved flexible cable 154″ may represent the flexible cable 154″ in the compact state.

Also shown in FIG. 14, in the compact state, the first and second collars (142, 144) may be pivoted down and as such, may expose an orifice on each collar (142, 144). In the extended state, the orifice on each collar (142, 144) may be proximate to one another and as such may be enclosed within the hinge assembly 140. However, in the compact state, the orifice on each collar (142, 144) may no longer be enclosed within the hinge assembly 140. Therefore, in an effort to reduce the amount of debris that may get into the first and second portions (136, 138) of the handle shaft 134, the first and second collars (142, 144) may each include a shield member that may block debris from settling into the first and second portions (136, 138) of the handle shaft 134. This may be desirable for the same reasons mentioned above in reference to the alignment of the first collar 142 and the second collar 144, which is, the efficient rotation of the flexible cable 154. If debris were to make its way into the handle shaft 134, then that debris could inhibit the flexible cable 154 from rotating to convey the rotation motion from the wheel assembly 110 to the counter 151. Thus, to ensure accurate operation of the measuring wheel 100, the shield members may cover the first collar 142 and the second collar 144 responsive to the hinge assembly 140 being disposed in the compact state. Similarly, the cable relief channel 260 disposed at each collar (142, 144) may also include a shield member to keep debris out of the hinge assembly 140 when the cable relief channel 260 is open with the hinge assembly 140 in the extended state.

FIGS. 15 and 16 depict an alternative embodiment of the analog counting assembly 550 compared to the embodiment shown in FIGS. 3-5. As shown in FIG. 15, the counter shaft 552 may be operably coupled to the flexible cable 154 via the first gear mesh 556. In this regard, the first gear mesh 556 may include a first bevel gear 560 operably coupled to a first end of the flexible cable 154 and a second bevel gear 562 operably coupled to the counter shaft 552. The first and second bevel gears (560, 562) may be oriented at approximately 90° to one another within the first gear mesh 556 such that the flexible cable 154 may extend substantially perpendicular to the counter shaft 552, and down the handle shaft 134 towards the wheel assembly 110. In this regard, the counter shaft 552 may rotate about an axis of rotation 552′ responsive to the flexible cable 154 rotating about its own axis of rotation 154′ that may be substantially perpendicular to the counter shaft axis of rotation 552′. The first and second bevel gears (560, 562) may accordingly be rotatably operably coupled via teeth disposed at each of the first and second bevel gears (560, 562). The flexible cable 154 may thus convey a rotational force from the wheel assembly 110 to the counter shaft 552, via the first gear mesh 556, and the counter 551 may accordingly convert the rotation of the counter shaft 552 into the distance traveled by the measuring wheel 100.

FIG. 16 depicts a perspective view of the first gear mesh 556, according to an example embodiment. In FIG. 16, the first gear mesh 556 may be shown being supported by a handle alignment member 570. The handle alignment member 570 may support the first gear mesh 556 proximate to the counter 551 so that the first gear mesh 556 operably couples the flexible cable 154 to the counter shaft 552. In other words, the handle alignment member 570 may support the first bevel gear 560 so that the first bevel gear 560 may be in precisely the correct position to operably couple with the second bevel gear 562 to transmit the rotational motion of the flexible cable 154 to the counter shaft 552 and ultimately to the counter 551. In this regard, the handle alignment member 570 may include a projection tab 572 with a support bracket 574 disposed at an end thereof. The support bracket 574 may extend around a portion of the first bevel gear 560 and the second bevel gear 562 to operably couple the first gear mesh 556 to the projection tab 572. In this regard, the first bevel gear 560 and the second bevel gear 562 may be free to rotate with the flexible cable 154 but also remain in position to operably couple with the each other and the counter shaft 552. As such, the support bracket 574 may properly locate the first gear mesh 556.

The handle alignment member 570 may further include a pair of fasteners 576. The pair of fasteners 576 may operably couple the support bracket 574 to the projection tab 572 to secure the first gear mesh 556 in place while allowing the first bevel gear 560 and the second bevel gear 562 to be free to rotate. The support bracket 574 may operably couple to both the first and second bevel gears (560, 562) to help the first gear mesh 556 maintain its operable coupling. Additionally, the pair of fasteners 576 may align with, and operably couple to, a pair of locating orifices in the handle 132 to aid in the assembly of the handle 132.

As seen in FIG. 16, in the first gear mesh 556, the second bevel gear 562 may extend substantially perpendicular to the first bevel gear 560 to form a T-shape engagement of the first and second bevel gears (560, 562). In other words, the second bevel gear 562 may be disposed substantially horizontal (i.e. parallel) to a ground plane along which the measuring wheel 100 may be operated, and the first bevel gear 560 may be disposed substantially vertical (i.e. normal) to the ground plane. The second bevel gear 562 may engage with the first bevel gear 560 at an opposite side of the first bevel gear 560 from the projection tab 572. This particular orientation may be beneficial for rotation direction purposes within the counting assembly 550. For example, as the measuring wheel 100 moves forward in direction during use, the flexible cable 154 may rotate clockwise. Thus, for the counter 551 to increment proportionally to the distance covered by the measuring wheel 100, the second bevel gear 562 may also rotate clockwise. In some other embodiments, however, the counter 551 may be configured to increment in a counterclockwise direction, and in such cases, the second bevel gear 562 may engage with the first bevel gear 560 in a position disposed on a directly opposite side of the first bevel gear 560, so that the first bevel gear 560 may turn the second bevel gear 562 in the counterclockwise direction. The second bevel gear 562, which may be secured to the counter shaft 552 via a pin, may also help to bias the first bevel gear 560 into the projection tab 572 by imparting a biasing force on the first bevel gear 560 directed parallel to the counter shaft 552 and towards the counter 551. In this regard, the second bevel gear 562 may be fixed in the axial direction via its operable coupling with the counter shaft 552. The counter 551, which may also be disposed in the handle and fixed in place via further support structures (e.g. ribs), may thus impart the biasing force onto the first bevel gear 560 via the counter shaft 552 and the second bevel gear 562. This orientation of the first gear mesh 556 may result in more secure support for the first gear mesh 556 via the projection tab 572.

FIGS. 17-19 depict various views of the hinge assembly 640 according to an example embodiment. The hinge assembly 640 may pivotably operably couple the first portion 136 of the handle shaft 134 to the second portion 138 of the handle shaft 134. The first portion 136 may be operably coupled to the handle 132 at a first end of the first portion 136 and to the hinge assembly 640 at a second end of the first portion 136. On the other hand, the second portion 138 may be operably coupled to the hinge assembly 640 at a first end of the second portion 138 and to the housing at a second end of the second portion 138. In this regard, the hinge assembly 640 may include a first collar 642 operably coupled to the second end of the first portion 136 and a second collar 644 operably coupled to the first end of the second portion 138. The first and second collars (642, 644) may be pivotably operably coupled to each other to achieve the hinging action of the handle shaft 134. In some cases, the first and second collars (642, 644) may operably couple to an exterior surface of the first and second portions (136, 138) of the handle shaft 134, respectively. As such, an interior of the first and second portions (136, 138) may be unobstructed. This may be desirable to improve the operation of the flexible cable 154 that may reside therein. In other words, if the flexible cable 154 were to get caught on something, it may be inhibited from transferring rotational motion to the counter 151. Thus, operably coupling the first and second collars (642, 644) to the exterior surface of the first and second portions (136, 138) may improve the operation of the flexible cable 154.

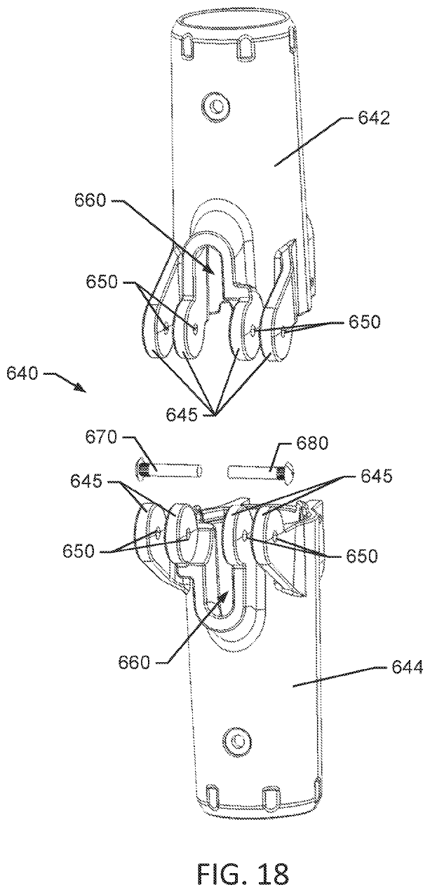

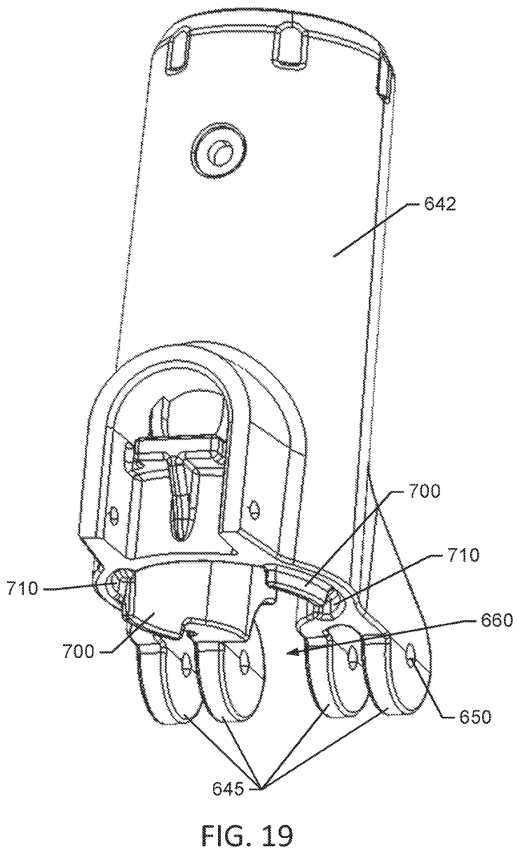

FIG. 17 depicts a rear perspective view of the hinge assembly 640 according to an example embodiment, FIG. 18 depicts a rear exploded view hinge of the assembly 640, and FIG. 19 shows a perspective view of the first collar 642 according to an example embodiment. In order to hingedly operably couple to one another, the first and second collars (642, 644) may each include at least one hinge lobe 645, and each hinge lobe 645 may include a bore 650 that may extend through the hinge lobe 645. In fact, in the embodiment shown in FIGS. 17-19, each of the first and second collars (642, 644) may include a total of four hinge lobes 645. The hinge lobes 645 may be disposed into two sets that may be separated by a cable relief channel 660 extending between each set. Accordingly, in some embodiments, each collar (642, 644) may include a first set of hinge lobes which may include first and second hinge lobes, and a second set of hinge lobes which may include the third and fourth hinge lobes. It should be appreciated, however, that in other cases, more or fewer hinge lobes 645 may be provided in total and/or in each set. In any case, the first set of hinge lobes of the first collar 642 may pivotably operably couple with the second set of hinge lobes of the second collar 644 via a first pin 670 extending through the bore 650 in each hinge lobe 645.

In this regard, the hinge lobes 645 may interface with each other in an interlocking manner. For example, two consecutive hinge lobes 645 from the first collar 642 may be separated by a hinge lobe 645 from the second collar 644. Thus, the first set of hinge lobes of the second collar 644 may pivotably operably couple with the second set of hinge lobes of the first collar 642 via a second pin 680 extending through the bore 650 in each hinge lobe 645. In an example embodiment, the first and second pins (670, 680) may be coaxially disposed along a pivot axis 690 and on opposing sides of the cable relief channel 660. Therefore, the hinge assembly 640 may include two, or perhaps more in some cases, pins (670, 680) to pivotably operably couple the first collar 642 to the second collar 644 via the hinge lobes 645. In some cases, including a total of four lobes 645 may increase the robustness of the hinge assembly 640. In an example embodiment, including a total of four lobes 645 may reduce the number of pinch points as well. In other words, the operator or anyone who may interact with the measuring wheel for that matter may have a reduced chance at pinching themselves in the hinge assembly 640.

Therefore, as discussed above, the hinge assembly 640 may be operable between an extended state in which the first and second shaft portions (136, 138) may be coaxial and disposed end-to-end (as seen in FIG. 17), and a compact state where first and second shaft portions (136, 138) may be substantially parallel and disposed side-by-side (as seen in FIG. 14). In an example embodiment, the first and second shaft portions (136, 138) may rotate up to 180° when exiting the extended state and going into the compact state.

FIG. 19 depicts a perspective view of the first collar 642 according to an example embodiment. In an example embodiment, the first and second collars (642, 644) may be a reflection of each other. In other words, they may be the same part with the same features, just flipped to operably couple with each other. In some cases, each of the first and second collars (642, 644) may include a male locating member 700 and a female locating member 710. In this regard, in the extended state, the male locating member 700 of the first collar 642 may operably couple to the female locating member 710 of the second collar 644 and the male locating member 700 of the second collar 644 may operably couple to the female locating member 710 of the first collar 642. Accordingly, the male and female locating members (700, 710) may ensure that the first and second collars (642, 644) align properly when pivoting into the extended state from the compact state. In doing so, the male and female locating members (700, 710) on each collar (642, 644) may help keep the interior region of the handle shaft 134 and the hinge assembly 640 unobstructed for proper rotation of the flexible cable 154 disposed therein. In other words, in the extended state, the first shaft portion 136, the first collar 642, the second collar 644 and the second shaft portion 138 may form a hollow cylindrical tube through which the flexible cable 154 may extend from the first gear mesh 156 to the second gear mesh 158. In contrast to that, in the compact state, the first collar 642 and the second collar 644 may form a 180° corner between the first and second shaft portions (136, 138). Thus, in the compact state, the flexible cable 154 may bend 180° to extend through the first and second collars (642, 644).

Some example embodiments may provide for a measuring wheel. The measuring wheel may include a wheel assembly which may include at least one wheel, a handle assembly which may include a handle and a shaft, a housing to which the handle assembly and the wheel assembly may be operably coupled, and an analog counting assembly which may convert rotation of the at least one wheel into a distance traveled by the measuring wheel. The analog counting assembly may include a counter disposed at the handle of the measuring wheel, and a flexible cable which may enable the handle shaft to fold and which may mechanically operably couple the counter to the wheel assembly for measuring the distance traveled when the handle shaft may not be folded.

The measuring wheel of some embodiments may include additional features, modifications, augmentations and/or the like to achieve further objectives or enhance performance of the measuring wheel. The additional features, modifications, augmentations and/or the like may be added in any combination with each other. Below is a list of various additional features, modifications, and augmentations that can each be added individually or in any combination with each other. For example, the analog counting assembly may further include a first gear mesh which may operably couple the flexible cable to the counter at a first end of the flexible cable, and a second gear mesh which may operably couple the flexible cable to the wheel assembly at a second end of the flexible cable. In an example embodiment, the counter may be a mechanical counter and may include a counter shaft. In some cases, the flexible cable may mechanically operably couple to the counter shaft via the first gear mesh and may transfer rotational motion from the flexible cable to the counter shaft. In an example embodiment, responsive to the at least one wheel rotating about a first axis of rotation, the second gear mesh may rotate the flexible cable about a second axis of rotation. In some cases, the first axis of rotation may be substantially perpendicular to the second axis of rotation. In an example embodiment, responsive to the flexible cable rotating about the second axis of rotation, the first gear mesh may rotate the counter shaft about a third axis of rotation. In some cases, the third axis of rotation may be substantially perpendicular to the second axis of rotation and substantially parallel to the first axis of rotation. In an example embodiment, the first and third axes of rotation may be substantially parallel to a surface along which the measuring wheel may travel. In some cases, the second axis of rotation may be substantially perpendicular to the surface on which the measuring wheel may travel. In an example embodiment, responsive to the counter shaft rotating about the third axis of rotation, the counter may display the distance traveled by the measuring wheel. In some cases, the analog counting assembly may further include a handle alignment member disposed at the handle. In an example embodiment, the handle alignment member may support the first gear mesh proximate to the counter so that the first gear mesh may operably couple the flexible cable to the counter shaft. In some cases, the handle may include a support member that may properly locate the first gear mesh in the handle alignment member. In an example embodiment, the handle alignment member comprises a support bracket that properly locates the first gear mesh. In an example embodiment, the hinge assembly may be operable between an extended state in which the first and second shaft portions may be coaxial and disposed end-to-end, and a compact state in which the first and second shaft portions may be substantially parallel and may be disposed side-by-side. In some cases, the first and second shaft portions may rotate up to 180° between the extended state the compact state. In an example embodiment, in the extended state, the handle and the wheel assembly may be disposed on opposite ends of the measuring wheel, and in the compact state, the handle may be disposed proximate to the wheel assembly.

Some example embodiments may provide for an analog counting assembly for a measuring wheel. The analog counting assembly may include a counter which may be disposed at a handle of the measuring wheel, a flexible cable which may mechanically operably couple the counter to a wheel assembly of the measuring wheel, a first gear mesh which may operably couple the flexible cable to the counter at a first end of the flexible cable, and a second gear mesh which may operably couple the flexible cable to the wheel assembly at a second end of the flexible cable. The analog counting assembly may convert rotation of at least one wheel of the wheel assembly into a distance traveled by the measuring wheel.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A measuring wheel comprising:
a wheel assembly comprising at least one wheel;
a handle assembly comprising a handle and a handle shaft that is foldable;
a housing to which the handle assembly and the wheel assembly are operably coupled; and
an analog counting assembly configured to convert rotation of the at least one wheel into a distance traveled by the measuring wheel,
wherein the analog counting assembly comprises a counter disposed at the handle of the measuring wheel, and a flexible cable to enable the handle shaft to fold and to mechanically operably couple the counter to the wheel assembly for measuring the distance traveled when the handle shaft is not folded.

2. The measuring wheel of claim 1, wherein the analog counting assembly further comprises:
a first gear mesh operably coupling the flexible cable to the counter at a first end of the flexible cable; and
a second gear mesh operably coupling the flexible cable to the wheel assembly at a second end of the flexible cable.

3. The measuring wheel of claim 2, wherein the counter is a mechanical counter comprising a counter shaft, and
wherein the flexible cable mechanically operably couples to the counter shaft via the first gear mesh to transfer rotational motion from the flexible cable to the counter shaft.

4. The measuring wheel of claim 3, wherein responsive to the at least one wheel rotating about a first axis of rotation, the second gear mesh rotates the flexible cable about a second axis of rotation, and
wherein the first axis of rotation is substantially perpendicular to the second axis of rotation.

5. The measuring wheel of claim 4, wherein responsive to the flexible cable rotating about the second axis of rotation, the first gear mesh rotates the counter shaft about a third axis of rotation, and
wherein the third axis of rotation is substantially perpendicular to the second axis of rotation and substantially parallel to the first axis of rotation.

6. The measuring wheel of claim 5, wherein the first and third axes of rotation are substantially parallel to a surface along which the measuring wheel travels.

7. The measuring wheel of claim 6, wherein the second axis of rotation is substantially perpendicular to the surface on which the measuring wheel travels.

8. The measuring wheel of claim 5, wherein responsive to the counter shaft rotating about the third axis of rotation, the counter displays the distance traveled by the measuring wheel.

9. The measuring wheel of claim 3, wherein the analog counting assembly further comprises a handle alignment member disposed at the handle, and
wherein the handle alignment member supports the first gear mesh proximate to the counter to operably couple the first gear mesh to the flexible cable and to the counter shaft.

10. The measuring wheel of claim 9, wherein the handle alignment member comprises a support bracket that properly locates the first gear mesh.

11. The measuring wheel of claim 2, wherein the handle shaft comprises a first shaft portion and a second shaft portion operably coupled to each other at a hinge assembly.

12. The measuring wheel of claim 11, wherein in an extended state, the first and second shaft portions are coaxial and disposed end-to-end, and
wherein in a compact state, the first and second shaft portions are substantially parallel and disposed side-by-side.

13. The measuring wheel of claim 12, wherein the first and second shaft portions rotate up to 180° between the extended state and the compact state.

14. The measuring wheel of claim 12, wherein in the extended state, the handle and the wheel assembly are disposed on opposite ends of the measuring wheel, and in the compact state, the handle is disposed proximate to the wheel assembly.

15. An analog counting assembly for a measuring wheel, the analog counting assembly comprising:
a counter disposed at a handle of the measuring wheel;
a flexible cable mechanically operably coupling the counter to a wheel assembly of the measuring wheel;
a first gear mesh operably coupling the flexible cable to the counter at a first end of the flexible cable; and
a second gear mesh operably coupling the flexible cable to the wheel assembly at a second end of the flexible cable,
wherein the analog counting assembly converts rotation of at least one wheel of the wheel assembly into a distance traveled by the measuring wheel.

16. The analog counting assembly of claim 15, wherein the counter is a mechanical counter comprising a counter shaft, and
wherein the flexible cable mechanically operably couples to the counter shaft via the first gear mesh to transfer rotational motion from the flexible cable to the counter shaft.

17. The analog counting assembly of claim 16, wherein responsive to the at least one wheel rotating about a first axis of rotation, the second gear mesh rotates the flexible cable about a second axis of rotation, and
wherein the first axis of rotation is substantially perpendicular to the second axis of rotation.

18. The analog counting assembly of claim 17, wherein responsive to the flexible cable rotating about the second axis of rotation, the first gear mesh rotates the counter shaft about a third axis of rotation, and
wherein the third axis of rotation is substantially perpendicular to the second axis of rotation and substantially parallel to the first axis of rotation.

19. The analog counting assembly of claim 15, wherein the analog counting assembly further comprises a handle alignment member disposed at the handle, and
wherein the handle alignment member supports the first gear mesh proximate to the counter to operably couple the first gear mesh to the flexible cable and to the counter shaft.

20. The analog counting assembly of claim 19, wherein the handle alignment member comprises a support bracket that properly locates the first gear mesh.
